(19) United States
(12) Patent Application Publication
(10) Pub. No.: US 2012/0239936 A1
(43) Pub. Date: Sep. 20, 2012

(54) CREDENTIAL TRANSFER

(75) Inventors: Silke Holtmanns, Klaukkala (FI); Nadarajah Asokan, Espoo (FI); Kari Timo Juhani Kostiainen, Helsinki (FI)

(73) Assignee: NOKIA CORPORATION, Espoo (FI)

(21) Appl. No.: 13/513,662

(22) PCT Filed: Dec. 18, 2009
(86) PCT No.: PCT/US09/68867

§ 371 Date: Jun. 4, 2012

(51) Int. Cl. G06F 21/00; H04L 9/32; H04L 9/30

(52) U.S. Cl. 713/176; 726/6; 713/168

(57) ABSTRACT

Methods and apparatus, including computer program products, are provided for credential transfer. In one aspect there is provided a method. The method may include receiving, at a first device, an authorization token; determining, at the first device, a delegation token, one or more credentials, and metadata; and providing, by the first device to a second device, the delegation token, the one or more credentials, and the metadata. Related apparatus, systems, methods, and articles are also described.

### FIELD

The present invention relates generally to communication networks. More specifically, the present invention relates to transferring credentials.

### BACKGROUND

A personal trusted device allows users to store and use their credentials securely. The credentials on a personal trusted device can be implemented using trusted execution environments (TrEEs), such as a trusted platform module (TPM), mobile trusted modules (MTM), JavaCard, M-Shield, as well as other form factors. Trusted execution environments are often available on many high-end personal computers and mobile phones.

Trusted execution environments, provide a trusted, secure processing environment, and may include at least a processor, a memory, and code. For example, a trusted execution environment may include one or more of the following features: a cryptographic processor, key storage, key generation, pseudo-random number generation, sealed storage, and the like. Examples of trusted execution environments and their features can be found in TPM Main Specification, Level 2, Version 1.2, Revision 103.

When a user wants to transfer credentials from one device to another (e.g., when the user buys a new device to replace an old, lost, damaged or stolen device), the transfer of a credential may take place using a removable trusted execution environment or an embedded trusted execution environment.

When the user's credentials are stored in removable trusted execution environments, such as JavaCards or SIM cards, credential transfer is intuitive from the user's point of view, e.g., the user may simply remove the removable trusted execution environment from the old device and insert the trusted execution environments into the new device. But even in this case, the transfer might be hampered due to different form factors, for example, the old and new device may utilize different size of cards.

On the other hand, handling credentials in embedded trusted execution environments is not as intuitive. Although less intuitive, the use of embedded trusted execution environments has, in some implementations, one or more features when compared to removable trusted execution environments. For example, embedded trusted execution environments are available in a wide range of devices from mobile phones to laptops. Moreover, removable trusted execution environments are often controlled by the device issuer (e.g. in the case of a SIM card, the mobile phone service provider/operator provides the SIM cared), so using removable trusted execution environments for third party credentialing may not always be possible due to restrictions imposed by the issuer (e.g. an operator may not agree that an banking application is loaded to the card he issued). In addition, embedded trusted execution environments are more cost efficient, especially for low-end, mass-market devices. Furthermore, embedded trusted execution environments may be tightly integrated with the device operating system (OS), so that a trusted path to the user can be realized.

Unlike credential transfer from removable trusted execution environments, transferring credential using embedded trusted execution environments is more challenging. In the case of embedded trusted execution environments, the credentials are typically exported from the trusted execution environments of the old device and imported into the trusted execution environments of the new device. For example, if the identity of the new device is known and the public key of the new device's trusted execution environments can be delivered to the old device in an authenticated manner, credential transfer is easy (e.g., the credentials can be encrypted in the trusted execution environments of the old device, so that they can only be decrypted inside the trusted execution environments of the new device). For this method to work effectively, the cryptographic keys of the new device should be known before the old device is no longer available (e.g., if a device is lost or stolen and the user goes to a shop and buys a new device, this approach cannot be applied).

There are, however, additional reasons why such a straightforward credential transfer is not always possible. First, users may have credentials from multiple credential provisioners, and each provisioner of the credential may have its own policies regarding the migration of credentials. While certain credential provisioners may allow the user to directly transfer the credentials from one device to another device, others credential provisioners may not allow credential transfer and require re-provisioning of credentials into the new device.

Having to re-provision credentials from multiple different provisioners is problematic from the usability point of view as each provisioning operation requires user authentication with respect to that particular provisioner's domain, making it difficult and impractical to assume that all credential provisioners would use, for example, the same single sign-on authentication system. If the user has credentials from, for example, a plurality of n provisioners that do not allow transfer of credentials, taking a new device into use would thus require n credential re-provisioning with n user authentication operations. Such a user experience would be far from ideal.

### SUMMARY

Methods and apparatus, including computer program products, are provided for credential transfer. In one aspect there is provided a method. The method may include receiving, at a first device, an authorization token; determining, at the first device, a delegation token, one or more credentials, and metadata; and providing, by the first device to a second device, the delegation token, the one or more credentials, and the metadata.

In another aspect there is provided a method. The method may include receiving, at a proxy, an authorization token; determining, at the proxy and in response to the received authorization token, a delegation token; and providing to a device one or more credentials based on the determined delegation token.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1A depicts a block diagram of a communication system;

FIG. 1B depicts a process for directly transferring credentials between two devices;

FIG. 2 depicts a process for transferring credentials using a proxy, such as a server;

FIG. 3 depicts an example implementation of a device including a trusted execution environment;

FIG. 4 depicts an example of a server used as a proxy for a credential transfer;

FIG. 5 depicts another process for direct credential transfer between two devices; and

FIG. 6 depicts another process for proxy-assisted credential transfer.

Like labels are used to ref to same or similar items in the drawings.

### DETAILED DESCRIPTION

The subject matter described herein relates to credential transfer and, in particular, a direct credential transfer between devices and a proxy-assisted credential transfer in which, for example, a server acts as a proxy for the credential transfer between the devices.

In implementations using a direct credential transfer between (or among) devices, the old and new devices are available to the user at the same time. When this is the case, the old device may encrypt one or more of the credentials (which are allowed to be transferred) to allow a direct transfer to the trusted execution environments (TrEE) of the new device. Because one or more of the credentials have a policy which does not allow a direct transfer between devices, a delegation token is generated to enable the new device to fetch any non-transferable credentials from the original credential provisioners, without requiring the user to re-authenticate to each of the original credential provisioners. The delegation token, which is securely stored at the proxy, authorizes the proxy to act on behalf of the user. In particular, the delegation authorizes that a re-provisioning is to be initiated to a new device on behalf of the user. This enables the credential issuer to know which new device the credentials are issued to, and the proxy does not store or handle the credentials.

In implementations using a proxy-assisted credential transfer, the old device creates a backup of transferable credentials to a proxy (e.g., a server), and delegates to the server credential re-provisioning. When the new device is available, the user authenticates the new device with a password or other suitable authentication mechanism. The server then pushes transferable credentials to the new device, and fetches, using a delegation token, the non-transferable credentials from the original provisioners to the new device. In this proxy-assisted scheme, once the old device creates a backup of the transferrable credentials to the server, the old device is no longer needed. As such, if the old device is lost, stolen, damaged, and/or not available, the credential transfer may still proceed as the server, which acts as a proxy, pushes the credentials to the new device. To each credential, some meta information is attached which identifies, for example, whether the credential can be backed-up on the server or has to be re-issued. If it is of the later type, then also some re-issuing contact address (e.g., a URL) is included in the metadata.

In some implementations including an embedded TrEE in the device, the TrEE provides secure storage for the device and a statistically unique asymmetric key. The public part of the key is typically certified by a trusted authority, such as the device manufacturer, as belonging to a valid TrEE. The private part of the key (i.e., the private key) is designed to never leave the TrEE. Additionally, the TrEE typically has a device-specific symmetric key that is only accessible inside the TrEE. The TrEE may also include volatile secure memory for secure execution, but this storage is typically not persistent secure memory. Examples of such TrEEs include M-Shield (which is commercially available from Texas Instruments), although other trusted execution environments may be used as well.

As noted, the subject matter described herein may provide a server which acts as a proxy in a credential transfer. The server is equipped with an embedded TrEE, providing secure storage for a device-specific asymmetric key. The public part of the key is typically certified by a trusted authority, and the trust root of this certification is typically installed into the TrEEs of the devices in a trustworthy manner (e.g. during device manufacturing). The private part of the key is designed to never leave the TrEE of the server.

Before providing detailed examples of direct credential transfer and proxy-assisted transfer, the following provides an example network environment in which the credential transfer may be implemented, although the credential transfer mechanisms described herein may be used in other wired and/or wireless networks as well.

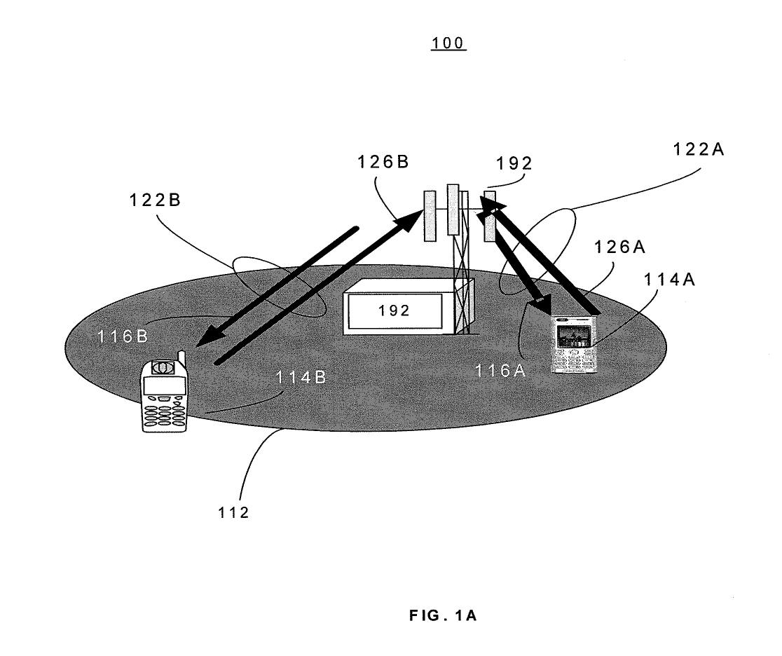

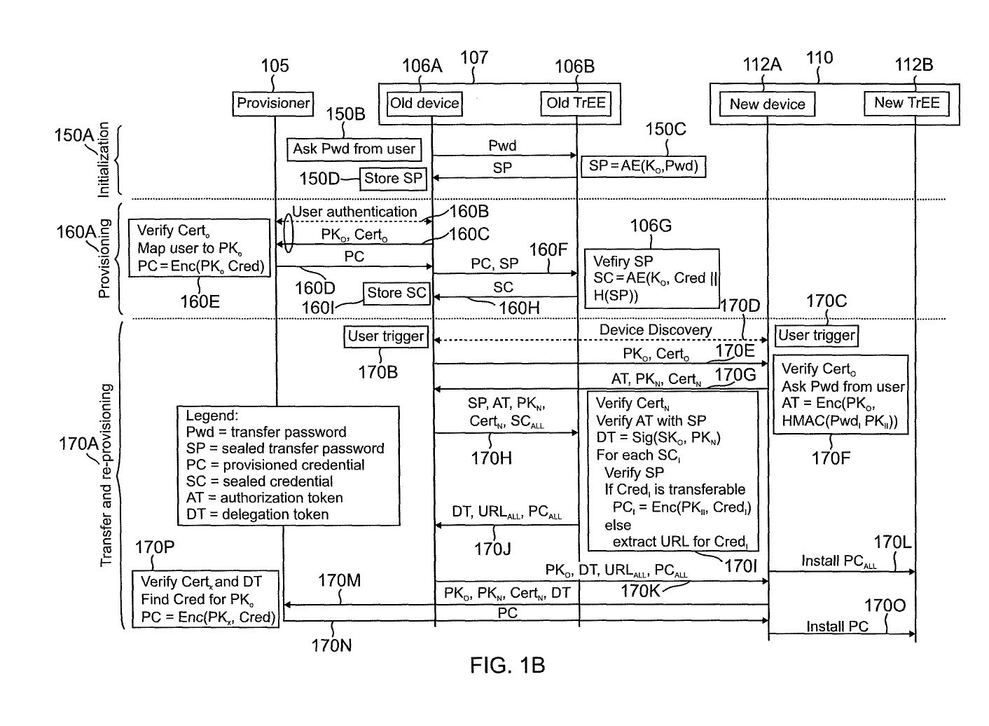

FIG. 1A is a simplified functional block diagram of a wireless communication system 100. Although wireless communication system 100 is depicted, any other type of wired and/or wireless networks may be used as communication mechanism (e.g., the Internet) for the transfer of credentials. The wireless communication system 100 of FIG. 1A is offered as an illustrative example. The communication system 100 includes a base station 192 supporting a corresponding service or coverage area 112 (also referred to as a cell). The base station 192 is capable of communicating with wireless devices, such as user equipment 114A-B, within its coverage areas. Although FIG. 1A depicts a single base station 192, cell 112, and user equipment 114A-B, the wireless communication system 100 may include other quantities of base stations, cells, and user equipment as well. Moreover, the wireless communication system 100 may include (or be coupled to) other networks as well including an Internet, an intranet, the public switched telephone network, wireless local area networks, as well as any other network(s).

The base station 192, in some implementations, comprises an evolved Node B (eNB) type base station or home (e) NB consistent with standards, including the Long Term Evolution (LTE) standards, such as 3GPP TS 36.201, “Evolved Universal Terrestrial Radio Access (E-UTRA); Long Term Evolution (LTE) physical layer; General description,” 3GPP TS 36.211, “Evolved Universal Terrestrial Radio Access (E-UTRA); Physical channels and modulation,” 3GPP TS 36.212, “Evolved Universal Terrestrial Radio Access (E-UTRA); Multiplexing and channel coding,” 3GPP TS 36.213, “Evolved Universal Terrestrial Radio Access (E-UTRA); Physical layer procedures,” 3GPP TS 36.214, “Evolved Universal Terrestrial Radio Access (E-UTRA); Physical layer—Measurements,” and any subsequent additions or revisions to these and other 3GPP series of standards (collectively referred to as LTE/EPS, or SAE standards).

Although FIG. 1A depicts an example of a configuration for base station 192, the base station 192 may be configured in other ways including, for example, relays, cellular base station transceiver subsystems, gateways, access points, radio frequency (RF) repeaters, frame repeaters, nodes, and include access to other networks as well. For example, base station 192 may have wired and/or wireless backhaul links to other network elements, such as other base stations, a radio network controller, a core network, a serving gateway, a mobility management entity, a serving GPRS (general packet radio service) support node, a network management system, and the like.

In some implementations, the wireless communication system 100 includes access links, such as links 122A-B. The access links 122A-B include downlinks 116A-B for transmitting to the user equipment 114A-B and uplinks 126A-B for transmitting from user equipment 114A-B to the base station 192, although in some implementations the links between the user equipment to and from the user equipment may be wired and/or implemented in other ways as well (e.g., WiFi, Bluetooth, etc.).

The user equipment 114A-B may be implemented as a mobile device and/or a stationary device. The user equipment 114A-B is often referred to as, for example, mobile stations, mobile units, subscriber stations, wireless terminals, or the like. A user equipment may be implemented as, for example, a wireless handheld device, a wireless plug-in accessory, or the like. In some cases, user equipment may include a processor, a computer-readable storage medium (e.g., memory, storage, and the like), a radio access mechanism, a user interface, and/or a trusted execution environment.

FIG. 1B depicts a diagram including a process and components for transferring credentials directly between devices. FIG. 1B includes a provisioner 105, a first device 107, and a second device 110. The first device 105 may comprise the old device 106A from which the credential is being transferred from and the old trusted execution environment (labeled TrEE) 106B. The second device 110 may include the new device 112A and the new trusted execution environment (labeled TrEE) 112B. The provisioner 105, the first device 107, and the second device 110 may be coupled by any communication channel including the Internet, an intranet, the public switched telephone network, the public land mobile network, and any other communication mechanism(s) including the communication system described with respect to FIG. 1A.

The provisioner 105 may be implemented as at least one processor and at least one memory configured to provided credentials to devices. In some implementations, the provisioner 105 may be associated with a service provider of a wireless network, and may be included as part of a home subscriber service and/or an authorization, authentication, and accounting server, although the provisioner 105 may instead be located at other locations and may not be associated with the service provider/network operator. Moreover, although FIG. 1B depicts a single provisioner 105, a plurality of provisioners may be implemented as well.

Moreover, in some implementations, the provisioner 105 may provide a credential with a policy which allows the credential to be transferred directly between devices, without requiring re-authentication at the provisioner 105. In other cases, the provisioner 105 may provide a credential with a policy which does not allow the credential to be transferred directly between devices, requiring thus re-authentication (as well as re-provisioning) at the provisioner 105.

The credential provided by the provisioner 105 may include any information to verify the identity of the user of the device(s). An example of a credential is an X.509 certificate. For example, the credential may include one or more of the following: a password, a digital certificate (e.g., a digital signature binding a public key with an identity), a one-time token, a phone number, and the like.

The first device 107 and the second device 110 may each be implemented as at least one processor, at least one memory, code, and a TrEE. In some implementations, the first device and/or the second device may each comprise user equipment as described herein.

FIG. 1B includes three general phases for direct credential transfer between the first and second devices 107 and 110. Those three phases are initialization 150A during which the user initializes the credential platform for credential transfer, provisioning 160A during which the user acquires credentials from multiple provisioners, and transferring and re-provisioning 170A during which the credentials are either transferred or re-provisioned to the new device 110.

At 150B, an authentication is requested of a user of the old device 106A. The authentication may take the form of a request for a password (labeled Pwd) from the user of old device 106A. For example, when the old device 106A is first used, the user may be asked to define a transfer password for the credential transfer. The use of the phrase “old device” refers to a device from which the credential is being transferred, and the phase “new device” refers to a device to which the credential is being provided.

At 150C, the transfer password is loaded into the TrEE 106B and sealed locally using a device-specific symmetric key, Kₒ, that is only accessible inside the TrEE 106B. The term “sealed” refers to encrypting the transfer password using a key in the TrEE. The encrypted password is then sent to the old device 106A, so that at 150D, the resulting sealed transfer password is persistently stored in an operating system file system of device 106A. Thus, the use of the transfer passwords helps ensure that the credential transfer are only transferred to the correct new device, e.g., the new device that belongs to the same user.

In some implementations, setting up the transfer password at 150B requires user input. However, some TrEEs do not support a trusted path to the user of the device to allow the above-described interaction at 150B. When this is the case, the initialization 150A should be done when the device is clean from any malware; otherwise, the initialization 150A may be vulnerable to malware (which for example may modify or steal the user's transfer password). Moreover, once the transfer password has been defined by the user, the transfer password, Pwd, may be fixed to avoid modification from malware attacks. Because the TrEE 106B typically does not have persistent secure memory, the transfer password may not be stored directly inside the TrEE 106B. Instead, the transfer password, which is sealed, is stored at the old device 106A as noted above. Furthermore, the transfer password may be defined before any of the credentials are installed on the device, allowing thus the transfer password to be bound to each credential installed on the device.

The next phase is provisioning 160A. Credential provisioning typically starts with user authentication at 160B. Each credential provisioner (e.g., provisioner 105) may have its own user authentication mechanism, defining how user authentication is performed.

In any case, the user provisioning authentication at 160B is typically bound to the provisioning protocol being used (e.g., by using a transport layer security (TLS) based connection). In the example of FIG. 1B, the old device 106A provides, at 160C, a certificate, e.g., digital certificate, Cert_{O}, and a key (e.g., public key, PK_{O}) of its TrEE 106B.

At 160E, the provisioner 105 verifies the digital certificate, Cert_{O}, and then stores a mapping between the user identity and the public key, PK_{O}, of old device 106A. The provisioner 105 then encrypts (labeled “Enc” at FIG. 1B) the credential, Cred, using the public key, PK_{O}, of the old device 106A.

At 160D, the provisioner 105 then responds to the old device 106A by sending one or more provisioned credentials, such as provisioned credential PC, which have been encrypted at 160E. At 160F, the old device 106A forwards the encrypted provisioned credential(s), PC, and the sealed transfer password, SP, to the TrEE 106B.

Different credential platforms may use different credential installation mechanisms and details of the credential installation are not relevant to credential transfer, except that the transfer password is bound to the installed credentials at 160G This is done by, for example, importing the provisioned credential, PC, into the TrEE 106B together with the sealed transfer password, SP. Inside the TrEE 106B, the credential can be decrypted using the private part of the key pair and locally sealed using the device-specific symmetric key, K_{O}. The local sealed credential, SC, can be bound to the transfer password by including a hash of the sealed password with the sealed credential. The sealed credentials can be sent at 160H to allow storage at 160I on the operating system side of old device 106A.

Each credential may include secret data, such as a key (e.g., an encryption key), and associated metadata, such as credential type. For example, the credential metadata may indicate whether the credential is transferable or non-transferable. In case of a non-transferable credential, a re-provisioning identifier, such as a uniform resource locator (URL), is included in the metadata of the credential as well. The URL identifies the provisioner of the non-transferable credential to allow the credential to be obtained using the delegation token (as described below).

Although FIG. 1B at 160A-I depicts an example of a provisioning protocol scheme, other credential provisioning protocols can be used as well.

The next phase 170A includes transferring and re-provisioning.

To transfer credential from the first device 107 to the second device 110, a user may trigger, at 170B-C, the credential transfer operation in both devices 107 and 110. Moreover, the devices 107 and 110 may include a wireless connection, such as a short-range wireless connection (e.g., Bluetooth, etc) to allow the devices 107 and 110 to discover one another at 170D.

At 170E, once a connection has been established between the two devices 107 and 110, the old device 106A sends to the new device 112A the public key, PK_{O}, of the old device 106A and certificate, Cert_{O} of the old device 106A.

At 170F, the new device 112A verifies the certificate and asks for the transfer password from the user of devices 107 and 110.

Moreover, the new device 112A creates, at 170F, an authorization token (labeled AT). The authentication token comprises a hash-based message authentication code (HMAC) calculated over the public key, PK_{N}, of the new device 112A and the transfer password, Pwd. The resulting HMAC is then encrypted using the public key, PK₀, of the old device 106A to prevent, for example, a brute force attacks due to possibly short password length by an attacker that is able to eavesdrop network communications. The transfer password can be obtained from the user in a trustworthy manner as the new device is, in some implementations, clean from any malware, which may tamper or steal the transfer password.

At 170G, the new device 112A sends to the old device 106A the authorization token (labeled AT), the public key (PK_{N}) of the new device 112A, and the certificate (Cert_{N}) of the new device 112A,

At 170H, the old device 106A loads and seals into TrEE 106B the items received at 170G as well as the sealed password, SP, and the sealed credentials, SC.

At 170I, the TrEE 106B verifies the new device's certificate, Cert_{N}, authentication token, AT, and sealed password (SP). After that, all locally sealed credentials are decrypted. The transfer password binding inside the sealed credentials is verified against the loaded transfer password to make sure that the transfer password has not been changed after the credential installation. Verification can be done by comparing the hash of the received and the stored secret or by comparing the values directly in case of plaintext storage or, in case of public key cryptography, applying a cryptographic key to the received message and verify that the calculation gives the expected result. Every transferable credential (including the credential type which can be determined from the credential metadata) is encrypted for the new device 112A using the public key of the old device 106A. For each non-transferable credential, a re-provisioning URL is extracted from the credential metadata to identify the location of a provisioner not allowing credentials to be transferred directly between devices.

Moreover, at 170I, the old device 106A and/or TrEE 106B creates a delegation token (labeled DT) for the new device 112A. The delegation token, DT, includes calculating a signature (e.g., a digital signature) over new device's 112A public key, PK_{N}, using the private key, SKₒ, of the old device 106A.

At 170I, if the credential, Cred, is relatively large, hybrid encryption can be used, e.g., the provisioner 105 first creates a fresh symmetric key k, encrypts k with public key encryption, and then encrypts the actual credential with a symmetric key k using a symmetric authenticated encryption mode.

At 170J, the delegation token, DT, one or more sealed credential(s), PC_{ALL}, and any metadata, such as a uniform resource locator (URL) (which identifies provisioners not allowing credentials to be transferred directly between devices) are sent by the old TrEE 106B to the old device 106A.

At 170K, the old device 106A sends its public key, PK₀, all encrypted transferable credentials, PC_{ALL,} the delegation token, DT, and a list of re-provisioning URLs to the new device 112A. At 170L, the new device 112A may then install the transferable credentials into its credential platform, such as TrEE 112B.

At 170M, the new device 112A may then contact the provisioner 105 (as well as other provisioners) of each non-transferable credential using the received list of URLs. At 170O, the contacted provisioner may verify the certificate, Cert_{N}, of the new device 112A and the delegation token, DT. Once verified, the provisioner may identify the credential(s) based on the public key, PK₀, of the old device 106A. At 170N-O, the identified credentials are sealed (e.g., encrypted) and sent to the new device 112A for installation at the new TrEE 112B. Thus, the credentials are sent to the new device 112, without requiring the user to provide authentication.

The delegated credential re-provisioning scheme described in the previous section is based on the assumption that both the old and the new devices 107 and 110 are available to the user at the same time. However, this may not always be the case. For instance, the user may have give away, lose, damage, etc. the old device obtaining the new device. In these cases, the credential transfer process cannot be direct, but instead include a proxy. The process to transfer credentials using the proxy (e.g., as server) is typically initiated before the new device is available and before the identity of the new device is known to the old device.

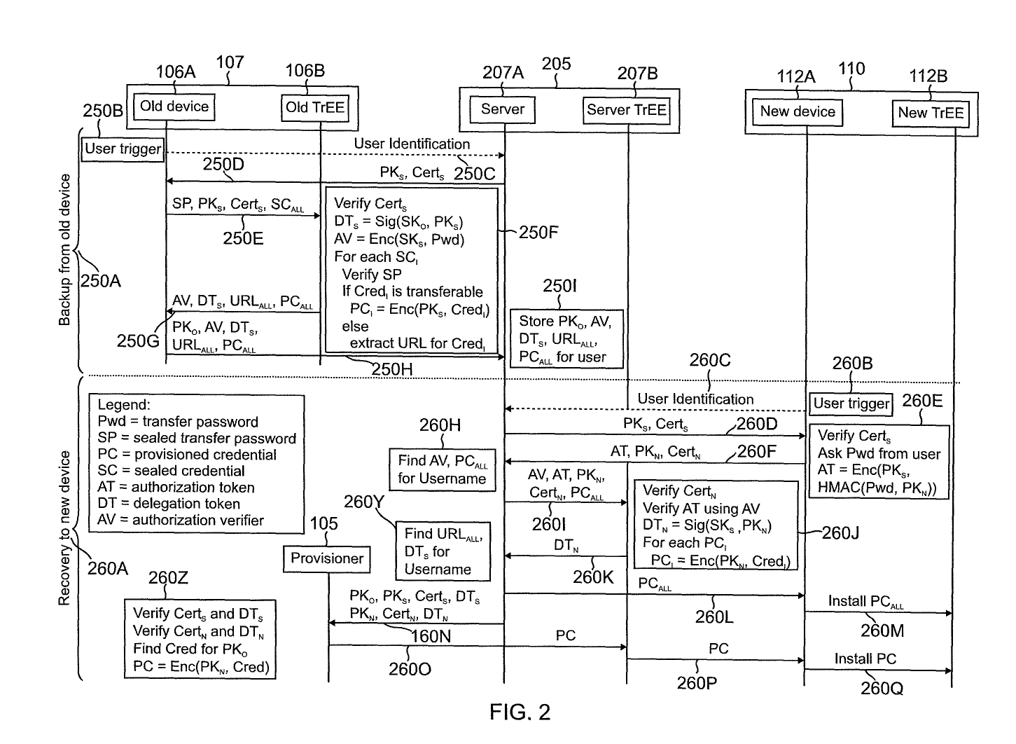

FIG. 2 depicts a diagram for using a proxy-assisted credential transfer process. FIG. 2 includes the first and second devices 107 and 110 and a proxy 205. The proxy 205 may be implemented as a processor (e.g., a computer including memory). Moreover, the proxy 205 may comprise a server 207A and a TrEE 207B. The devices 107, 110, and 205 may be coupled by any communication channel including the Internet, an intranet, the public switched telephone network, the public land mobile network, and any other communication mechanism, such as the communication system described with respect to FIG. 1A.

In some implementations, the proxy (e.g., device 205) may reside in, for example, the Internet (which may be accessible and/or coupled to communication system 100). The proxy may be access by user equipment (e.g., device 110) in a variety of ways. However, in some implementations, the user equipment, such as a mobile phone, accesses the proxy as follows. The user equipment access via a wired and/or wireless connection (e.g., Bluetooth) to a network access point, and then connects using a secure protocol, such as HTTPS or IPSEC, to the proxy. The re-issuing of the credential from the provisioner to the proxy or to a device may be implemented in a variety of ways including, for example, via a short message service (SMS), a wireless access protocol (WAP) push, a generic bootstrapping architecture (GBA) push, and/or an open mobile alliance (OMA) device management push. The credential may be sent (e.g., pushed) using a HTTP URL, in which the credential can be fetched. Moreover, the credential may be sent by the provisioner in accordance with 3GPP TR 33.812, Feasibility study on the security aspects of remote provisioning and change of subscription for Machine to Machine (M2M) equipment.

The proxy-assisted credential transfer of FIG. 2 may include credential transfer initialization and provisioning similar to the initialization 150A and provisioning 160A described above. However, the proxy-assisted (also referred to herein as server-assisted) credential transfer may further include a backup and delegation phase 250A (e.g., to provide a credential backup and delegation from the old device) and a recovery phase 260A (e.g., to provide credential recovery from the server to the new device).

At 250B, the credential transfer process may starts when the user triggers a credential transfer from the first device 107 including the old device 106A and TrEE 106B. The old device 106A connects to the server 207A and, at 250C, identifies the user of the old device 106A to the server 207A. This user identification may be based on, for example, a single sign-on system used by the service provider running the server 207A. The security of credential transfer is thus not dependent on this user authentication as it is just used to map the credential stored at the server 207A to a correct user.

At 250D, once the user has been identified, the server 207A sends to the old device 106A the server's 207 public key, PK, and certificate, Certₛ.

At 250E, the old device 106A loads into the TrEE 106B the public key, PKₛ, of the server 207A, the certificate, Certₛ, of the server 207A, the sealed transfer password, SP, and one or more sealed credentials, SC_{ALL}.

At 250F, the old device 106A and/or the old TrEE 106B verify the server certificate, Certs, and creates a delegation token, DTₛ, for the server 207A by digitally signing the public key, PKₛ, of the server 207A using the secret key, SKₒ, of the old device 106A. The old device 106A and/or old TrEE 106B also decrypts the sealed transfer password, and creates an authorization verifier, AV, by encrypting the transfer password, Pwd, with the server's public key, PKₛ. Each sealed credential is then processed as described herein with respect to the direct credential transfer, e.g., the transfer password is checked for each credential, transferable credentials are encrypted for the server, and the re-provisioning URL is extracted for the non-transferable credentials to allow locating the provisioners not allowing a direct transfer of credential between devices.

At 250G the old TrEE 106B sends the authorization verifier, AV, delegation token, DTₛ, for the server 207A, re-provisioning URLs, and provisioned credentials, PC, to the old device 106A.

At 250H, the old device 106A sends its public key, PK₀, authorization verifier, AV, delegation token, DTₛ, for the server 207A, encrypted transferable credentials, PC, and list of re-provisioning URLs to the server 207A, which then stores them, at 250I, for the user which is transferring credentials.

The next phase, 260A, relates to credential recovery to a new device, such as device 110.

At 260B, the user triggers from the new device 112A the credential recovery, which causes a connection to be established to the server 207A and identifies, at 260C, the user in similar fashion as in previous phase described with respect to 250C.

At 260D, the server 207A sends to the new device 112A the public key, PKₛ, of the server 207A and certificate, Certₛ, of the server 207A.

At 260E, the new device 112A verifies the certificate, Certₛ, of the server 207A and asks for a transfer password from the user of the new device 112A. An authorization token, AT, is also created by the new device 112A and/or new TrEE 112B. The authorization token, AT, created at 260E is similar to the authorization token used in direct transfer process described with respect to FIG. 1B). To avoid attacks to the transfer, the new device 112A may be in a condition in which it is not infected with malware that might compromise the transfer password.

At 260F, the new device 112A sends to the server 207A the public key, PK_{N}, of the new device 112A, the certificate, Cert_{N}, of the new device 112A, and the authorization token, AT.

At 260H, the server 207 finds for the user implementing the credential transfer (e.g., identified by username), the authorization verifier, AV, and one or more credentials, PC_{ALL}.

At 260I, the server 207A sends to, or loads into, the TrEE 207B one or more of the following: the authorization verifier, AV, the authorization token, AT, the public key, PK_{N}, of new device 112A, the certificate, Cert_{N}, of new device 112A, and one or more credentials, PC_{ALL}.

At 260J, the TrEE 207B verifies the certificate, Cert_{N}, of new device 112A, and checks that the authorization token, AT, has been created with the same transfer password as the authorization verifier, AV. If this is the case, the server 207A creates a delegation token, DT, for the new device 112A by signing the public key, PK_{N}, of the new device 112A using the secret key, SKₛ, of the server 207A. The TrEE 207B also encrypts one or more of the transferable credentials, PCi, for the new device 112A.

At 260K, the delegation token, DT_{N}, is sent by the TrEE 207B to the server 207A.

At 260L, the server 207A sends to the new device 112A the one or more credentials, PC_{ALL}, so that the credentials, PC_{ALL}, can be installed on the TrEE 112B at 260M.

At 260N, the server 207A may connect to one or more credential provisioners, such as provisioner 105. The server 207A then sends to the provisioner (e.g., provisioner 105) one or more of the following: the public key of the old device, PK_{O}, (which is used for finding the correct user credentials); the public key of the server 207A, PKₛ; a certificate, Certₛ, of the server 207A; a delegation token, DTₛ, of the server 207A; a public key, PK_{N}, of the new device 112A; a certificate, Cert_{N}, of the new device 112A; and a delegation token, DT_{N}, of the new device 112A.

At 260Z, the provisioner 105 verifies that the server 207A has been delegated by the old device 106A, and then that the new device 112A has been delegated by the server 207A. If this is the case, the provisioner 105 may then encrypt the credential, PC, for the new device 112A. At 260O-Q, the encrypted credential, PC, is returned to the server 207A, which forwards it to the new device 112A, where it can be installed to the TrEE 112B.

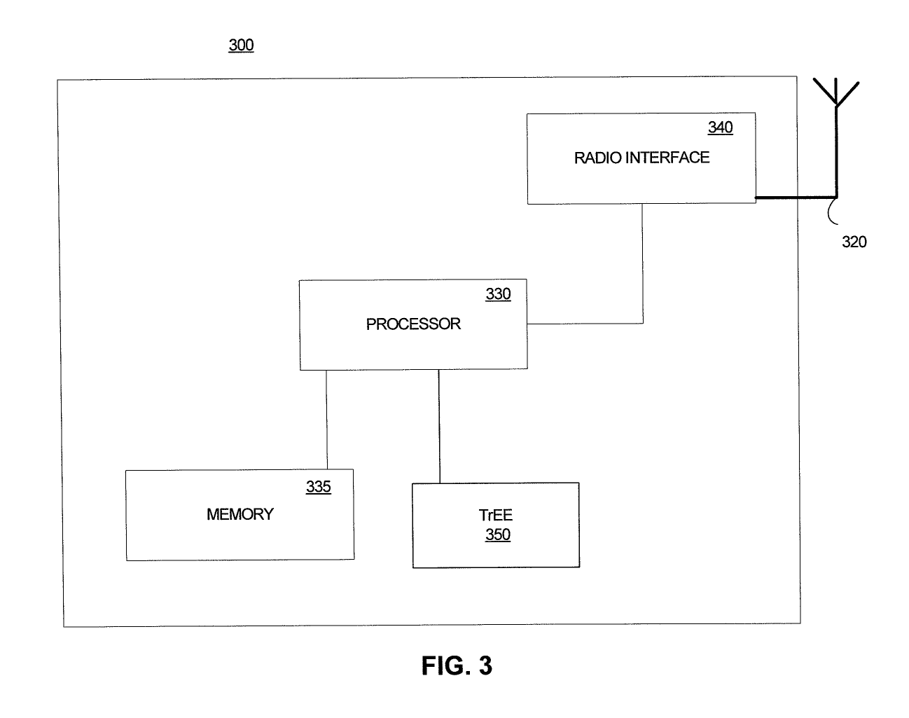

FIG. 3 depicts an exemplary device 300, which may be used as old device 107 and/or new device 110. In implementations where the devices 107 and 110 are implemented as user equipment, the device 300 may include an antenna 320 and a trusted platform, such as TrEE 350, although the device 300 may not include an antenna and instead include a wired network interface (e.g., a processor, such as a computer with a network interface, such as a WiFi or Bluetooth, connection to the Internet or other network). In the case the device includes an antenna 320, the device 300 may also include a radio interface 340, which may include other components, such as filters, converters (e.g., digital-to-analog converters and the like), symbol demappers, an Inverse Fast Fourier Transform (IFFT) module, and the like, to process symbols, such as OFDMA symbols, carried by a downlink or an uplink. In some implementations, the user equipment may also be compatible with IEEE 802.16, LTE, LTE-Advanced, and the like. The device 300 may further include a processor 330 for controlling the user equipment and for accessing and executing program code stored in memory 335 (which configures the processor to perform operations as described above with respect to FIGS. 1B, 2, 5, and 6).

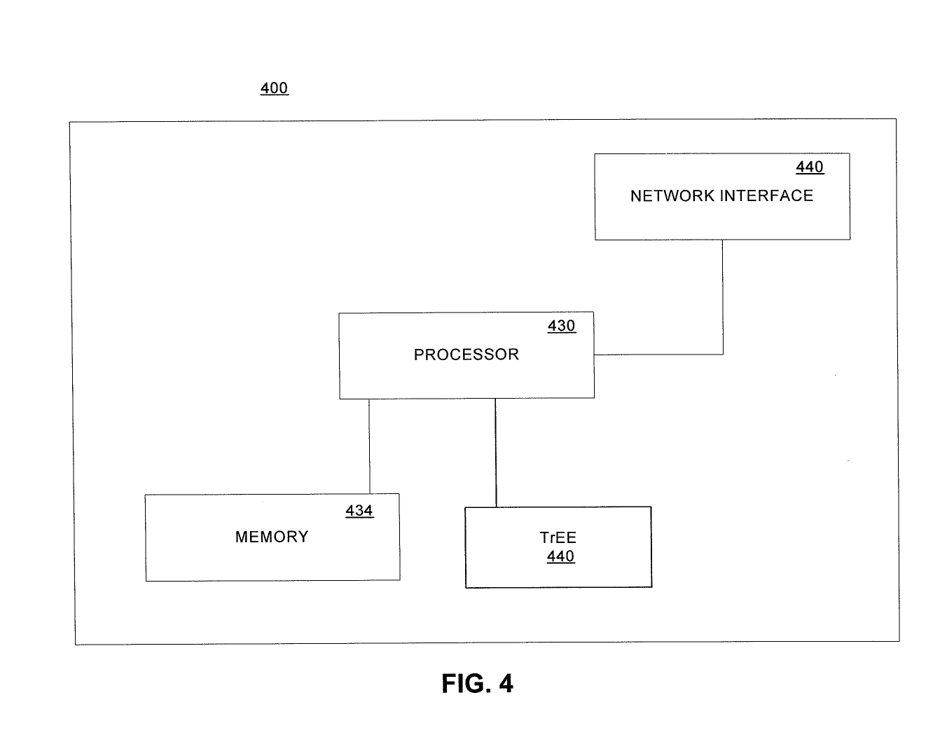

FIG. 4 depicts an exemplary server 400, which may be implemented at server 205. The server 400 may include a network interface 440 for coupling to a wireless (e.g., in accordance with a standard, such as IEEE 802.16, LTE, LTE-Advanced, and the like), and/or to a wired network. The server 400 further includes a processor 430 for controlling server as described above with respect to FIGS. 1B, 2, 5 and 6 and for accessing and executing program code stored in memory 435 (which configures the processor to perform operations as described above with respect to FIGS. 1B, 2, 5 and 6).

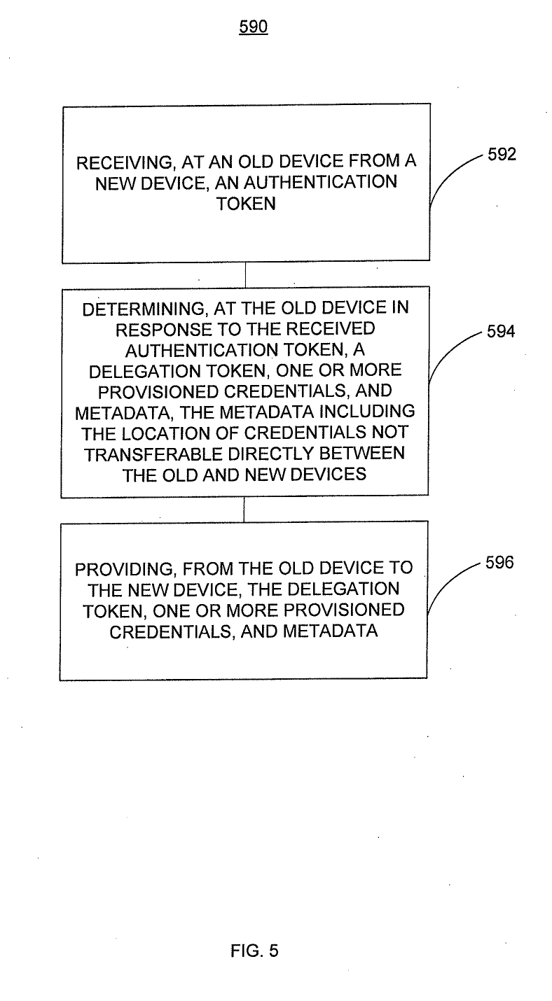

FIG. 5 depicts another process for direct credential transfer between two devices. Referring to FIG. 5, at 592, a first device, such as old device 107, receives at least an authentication token from another device, such as new device 110. In some implementations, the old device 107 may receive other information as well (e.g., information described above with respect to 170G).

At 594, the old device determines, in response to the received authentication token, a delegation token. The old device may also determine other information including retrieving credentials and metadata representing the location of credential provisioners that must be contacted directly to obtain a credential (e.g., in the case of non-transferable credentials that cannot be transferred between devices without re-authenticating with the provisioner). In some implementations, the old device 107 may determine other information as well (e.g., information described above with respect to 170I).

At 596, the old device provides to the new device at least a delegation token, one or more provisioned credentials, and the metadata. In some implementations, the old device 107 may provide this information as noted above at 170K).

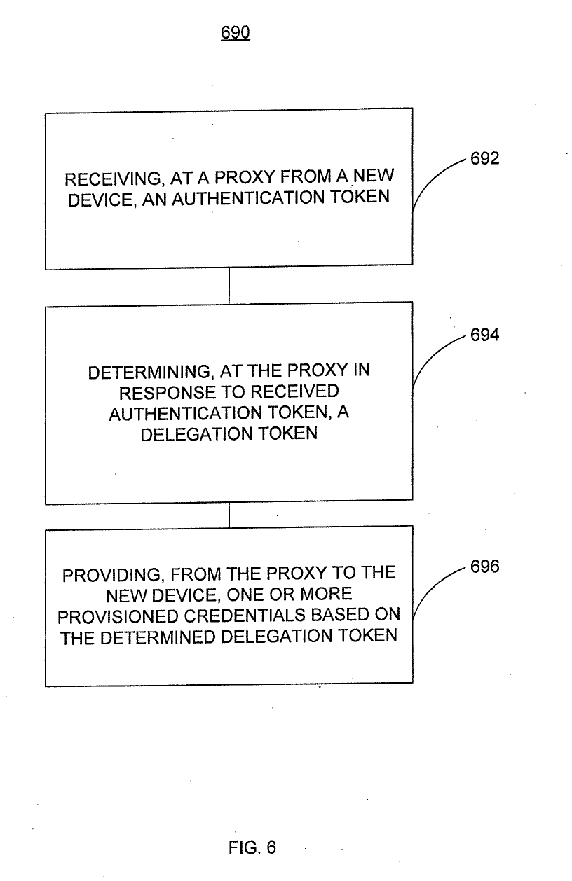

FIG. 6 depicts another process for proxy-assisted credential transfer between two devices. Referring to FIG. 6, at 692, a first device, such as server 205 (which acts as a proxy), receives at least an authentication token from another device, such as new device 110. In some implementations, the server 205 may receive other information as well (e.g., information described above with respect to 260F).

At 694, the server 205 determines, in response to the received authentication token, a delegation token. The old device may also determine other information including information described above with respect to 260J.

At 696, the server 205 provides, based on the delegation token, one or more provisioned credentials to the new device 112. In some implementations, the server 205 provides may provide this information as noted above at 260L. Moreover, the server 205 may provide the delegation token (as well as other information) to one or more provisioners to initiate the transfer of non-transferable credentials (e.g., credentials requiring re-authentication at the provisioner) as described above at 260N-P.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1. A method comprising:
receiving, at a first device, an authorization token;
determining, at the first device, a delegation token, one or more credentials, and metadata; and
providing, by the first device to a second device, the delegation token, the one or more credentials, and the metadata.

2. The method of claim 1 further comprising:
receiving a public key of the second device and a certificate of the second device.

3. The method of claim 1, wherein the receiving further comprises:
receiving, at the first device, the authorization token, a public key of the second device and a certificate of the second device, wherein the authorization token, the public key, and the certificate are received in response to a verification of a password associated with the one or more credentials.

4. The method of claim 1, further comprising:
determining the authentication token by encrypting, using a public key of the first device, a hash message authentication code of a password and a public key of the second device.

5. The method of claim 1, wherein the determining the delegation token further comprises:
calculating, using a private key of the first device, a digital signature of a public key of the second device.

6. The method of claim 1, wherein the metadata include location information for a provider of at least one of the one or more credentials, the at least one of the one or more credentials transferrable only between the provider and at least one of the first device and the second device.

7. A method comprising:
receiving, at a proxy, an authorization token;
determining, at the proxy and in response to the received authorization token, a delegation token; and
providing to a device one or more credentials based on the determined delegation token.

8. The method of claim 7, wherein the receiving further comprising:
receiving, at the proxy, a public key of the device and a certificate of the device.

9. The method of claim 7, wherein the receiving further comprises:
receiving, at the proxy, the authorization token, a public key of the device and a certificate of the device, wherein the authorization token, the public key, and the certificate are received in response to a verification of a password associated with the one or more credentials.

10. The method of claim 7, further comprising:
determining the authentication token by encrypting, using a public key of the proxy, a hash message authentication code of a password and a public key of the device.

11. The method of claim 7, wherein the determining the delegation token further comprises:
calculating, using a private key of the proxy, a digital signature of a public key of the device.

12. The method of claim 7, wherein the metadata include location information for a provider of at least one of the one or more credentials, the at least one of the one or more credentials transferrable by the provider.

13. An apparatus comprising:
at least one processor; and
at least one memory, wherein the at least one processor and the at least one memory are configured to provide at least the following:
receive an authorization token;
determine a delegation token, one or more credentials, and metadata; and
provide to a device the delegation token, the one or more credentials, and the metadata.

14. The apparatus of claim 13, wherein the apparatus is further configured to:
determine the authentication token by encrypting, using a public key of the apparatus, a hash message authentication code of a password and a public key of the device.

15. The apparatus of claim 13, wherein the processor being configured to determine the delegation token is further configured to:
calculate, using a private key of the apparatus, a digital signature of a public key.

16. An apparatus comprising:
at least one processor; and
at least one memory, wherein the at least one processor and the at least one memory are configured to provide at least the following:
receive an authorization token;
determine a delegation token; and
provide to a device one or more credentials based on the determined delegation token.

17. The apparatus of claim 16, wherein the apparatus is further configured to:
determine the authentication token by encrypting, using a public key of the apparatus, a hash message authentication code of a password and a public key of the device.

18. The apparatus of claim 16, wherein the processor being configured to determine the delegation token is further configured to:
calculate, using a private key of the apparatus, a digital signature of a public key of the device.

19. A computer-readable medium including code, which when executed on at least one processor, provides operations comprising:
receiving an authorization token;
determining a delegation token, one or more credentials, and metadata; and
providing the delegation token, the one or more credentials, and the metadata.

20. A computer-readable medium including code, which when executed on at least one processor, provides operations comprising:
receiving an authorization token;
determining a delegation token; and
providing one or more credentials based on the determined delegation token.
